(19) United States
(12) Patent Application Publication
(10) Pub. No.: US 2009/0324456 A1
(43) Pub. Date: Dec. 31, 2009

(54) Linear allignment chamber for carbon dioxide large volume disposal

(76) Inventor: Edward Milton McWhorter, Citrus Heights, CA (US)

Correspondence Address: Edward M. McWhorter, 6931 Greenbrook Circle, Citrus Heights, CA, 95621, US

(21) Appl. No.: 12/462,654

(22) Filed: Aug. 7, 2009

Related U.S. Application Data
(63) Continuation-in-part of application No. 12/286,888, filed on Oct. 3, 2008.
Application No. 12/286,888 is a continuation-in-part of application No. 11/075,218, filed on Mar. 9, 2005, now Pat. No. 7,381,378.
Application No. 11/075,218 is a continuation-in-part of application No. 12/055,093, filed on Mar. 25, 2008.
Application No. 12/055,093 is a continuation-in-part of application No. 10/072,166, filed on Feb. 11, 2002, now Pat. No. 6,653,007.

(51) Int. Cl. B01J 19/08

(52) U.S. Cl. 422/186.04

(57) ABSTRACT

An invention for linear orientation of electron depleted ionic gaseous streams required for outer shell covalent bonding of carbon dioxide molecular particles and clarified nitrogen gas removed from the combustion products of coal fired furnaces using calcium metal components of electrolytic fuel cell alkaline spent electrolyte or other sources in the intermediate synthesis of calcium cyanamide and in subsequent process synthesis for ammonia and a large variety of cyanagenic chemicals. A new method of generating actinic radiation in the terahertz frequency range is presented.

### CROSS REFERENCES

The invention is a continuation-in-part of my co-pending application Ref. 1.
Ref. 1 U.S. patent application Ser. No. 12/286,888 filed Oct. 3, 2008 Polar Ordinate Chamber
Ref. 2 U.S. Pat. No. 7,381,378 B2 filed Mar. 9, 2005 Coal Flue Gas Scrubber
Ref. 3 U.S. patent application Ser. No. 12/055,093 filed Dec. 26, 2007 Potassium Electric Generator and Chemical Synthesizer
Ref. 4 U.S. Pat. No. 6,653,007 filed Feb. 11, 2002 Hydrogen Generator

### BACKGROUND OF THE INVENTION

The disposal of large quantities of gaseous carbon dioxide captured in the coal flue gas scrubber of Ref. 2 with large quantities of spent calcium rich liquid from Fuel Cell operation of Ref. 4 are simultaneously ionized and prepared in Ref. 3 capacitor tuyere and stereo-chemically aligned and brought together in the present invention to produce calcium cyanogen and other compounds.

The present invention is a nonmagnetic stereo-chemical electrical circuit for linear alignment by induced actinic response of the positively charged product streams of Ref. 3 said capacitor tuyere.

The said electrical circuit of the present invention is comprised of a plurality of high electrical resistance filament wire segments specifically formed and connected in parallel circuit between two high intensity voltage bus-bars. The high voltage input to the said bus-bar filament circuits is pulsating direct current from the capacitor electron collecting circuit of the said capacitor tuyere reaction chamber of Ref. 3. Each individual electrical pulse from the said pulsating direct current is separate. However, flow within the interval between pulses in said electrical circuit is continuous being maintained by the current flow of the capacitor die-away factor of the said capacitor tuyere flowing through the said circuit during the intervening period between pulses. The direct current pulses from Ref. 3 are hereinafter termed the multiplexing signal or current input.

The efficiency of chemical reactions in which outer electron bonding is achieved during a given process is determined in large measure by the energy expended to produce the desired product yield. The best example of this relationship is the production of cyanogenic compounds or the Haber process used in the production of ammonia. The Haber process is the major controlling production process in the manufacture of nitrated fertilizers consuming more than 1 percent of the world energy supply and more than 5 percent of the world natural gas production. The said Haber reactions are random requiring high temperature and pressure and therefore are energy intensive.

If the chemical reactions within a reaction vessel are dependent on random mean-free encounter the process duration is lengthened statistically by simple chance encounter and becomes much more costly. The process yield and production costs are significantly improved when the chemical reactions are controlled by radial alignment as in the instance of Ref. 1 or by linear alignment as obtained in the present invention.

The fixation of nitrogen to hydrogen or to carbon is accomplished in nature at normal atmospheric temperature and pressures in animal metabolism and in plants by photosynthesis. In the latter reaction, fixation is more directly accomplished by actinic induced photonic reaction. In the industrial process the energy required to thermally rupture the nitrogen triple bond is 225.5 Kcal/mol. The said nitrogen in this instance is obtained as processed emission from the facility smoke stack above the facility scrubber of Ref. 2 and the carbon-dioxide is obtained from the said scrubber storage facility of Ref 2. In the invention process the nitrogen fixation to the carbon atom of carbon dioxide molecule is a method of sequestration and disposal which does not entail long periods of time for dormant storage as in the instance of geo-sequestration but instead produces an immediate value-added product that can be sold quickly on the open market. This method of disposal is preferred since it produces a marketable product instead of an operating overhead expense and therefore becomes profitable and does not require space or facilities within the public domain subject to governmental regulation.

The large volume disposal of carbon dioxide from coal-fired furnaces begins with the capture of this material in the facility flue gas scrubber of Ref. 2. Carbon dioxide contains two double bonds and in this form is not reactive because it cannot take up any more electrons as long as the double bonds remain intact. Activation energy is supplied (Ref. 3) to open one double bond of the molecule, it then becomes reactive with another CO₂ molecule or with other types of positively charged particles within the radial alignment chamber of Ref. 1 to form calcium carbide and acetylene or in the linear alignment chamber of the present invention to form dicarboxylic compounds. In this latter form two molecules of carbon dioxide are brought together in a positive rich ionic environment of alkaline metals from Ref. 3 to form dicarboxylic derivatives having carboxyl groups. The said carboxylic groups are reacted with the alkaline metal rich liquid effluent of Ref. 4 of spent electrolyte to form intermediary reagents for further chemical synthesis.

Photons have no mass and therefore no magnetic pole therefore their influence on reaction rates is not kinetic or magnetic, it is phototropic. The photosynthesis in plants, duplication, or heliotropic response in opening and closing with sunlight, have not as yet been reproduced in the laboratory. The damaging effect of light exposure from camera flash bulbs on ancient Egyptian tombs and temple walls hieroglyphics is now prohibited. Camera flash bulbs produce a full range of light frequencies. In the present invention the light producing filaments are designed to produce actinic radiation principally in the terahertz range. The ability of photons to effect chemical reaction rate to be used as a stereo-chemical facility in synthesis are believed to result from their ability to produce cascading secondary emissions at given frequencies. As an example the chlorination of methane in the dark is extremely slow, but in the presence of UV light the reaction is explosive. In this instance the reaction rate is not related to temperature but to actinic UV alignment in which the individual reactions are subject to high exponential secondary photo emission multiplication which appear to occur simultaneously. In the present invention stereo-chemical alignment is created by photonic radiation in a region between the lower IR and microwave range of the electromagnetic spectrum in the terahertz frequencies (10¹² hz) in the longer wave lengths.

Terahertz radiation has strong penetrating capability but will not pass through metals or aqueous mixtures rich in electrons. A good example of this characteristic is in diffusion flames in which the fuel and oxidizer are not premixed, the effect of terahertz radiation on flame propagation is minimal. However in a combustion field of premixed reactants in juxtaposition before ignition, as in the case of an internal combustion engine induction charge, terahertz radiation exciting the unburned mixture ahead of the combustion wave results in an exponential increase in reaction rate and ultimately terminates the burning; cycle in pre-ignition ahead of the combustion front and produces destructive engine knocking. Solutions to the problem has been to introduce a metal, such as tetraethyl lead, or a water injection to inhibit terahertz penetration. Ethyl alcohol which holds dissolved water is now used exclusively in automotive gasoline fuels as an anti-knock additive.

Positively charged carbon dioxide ions from Ref. 2 and spent calcium oxide electrolyte from Ref. 4 are activated in Ref. 3 capacitor tuyere creating a reactive system further depleted of excess electrons and therefore do not inhibit the penetration of actinic radiation in the terahertz frequencies. Terahertz actinic radiation is the proposed aligning frequency of the present invention.

Electrons spin about their own axis while in motion rotating about a much heavier nucleus and this said individual spin characteristic is also present when they are only free-passing unassociated through a conductor. The said electron spin produces a negative field charge. When a strong emf is generated in a conductor the electrons are accelerated and the lagging momentum change results in the electrons being brought closer together, in the lagging momentum called electron compaction. Compaction is greatest when the conductor is bent resulting in higher frictional losses increasing the effect of the said momentum lag. Electron compaction-results in electron field compression since the like negative charge of each electron field is negative resulting in the generation of repulsive force between fields which in turn results in field distortion. Distortion increases during the period in which the filament curvature is greatest, the radius of field gyration in these instances can no longer follow the spin gyration of the generating electron and an actinic field is generated and is emitted perpendicularly to each generating angle of gyration. This is the actinic field produced in the terahertz frequency range proposed by the present invention.

Electrons entering the bent curvature of the said filaments from the inlet bus-bar are traveling at a very high rate (v=7.88×10⁶ cm sec). On entering the high resistance of the filament wire they are slowed. The slowing action causes the electrons to lose momentum and the newly entering faster electrons begin to encounter the slower electrons ahead and begin to pile up in compaction. This is where electron compaction begins. Electron compaction results in the negative charged spherical fields such that they begin to be compressed into unsymmetrical spheroids. As the curvature of the filament steepens the said spherical fields compressed are distorted at the outer major turning radius of the filament wire. Near the bottom of the filament bend where the field radius of gyration can no longer follow the electron spin actinic wave lengths in excess of 700 nm are emitted. The said longer wave lengths are in the terahertz region and are capable of penetrating the alignment chamber ceramic wall to produce secondary emissions and covalent bonding in the positive charged ionic stream flowing within the said ceramic alignment chamber.

### SUMMARY OF THE INVENTION

The invention is an electromagnetic circuit for the generation of actinic radiation into a flowing chemical process stream. The radiation frequency of the generating circuit is designed for operation between the lower infrared and shorter microwave range of the electromagnetic radiation spectrum. The intended application of the invention is for the sterochemical alignment and positioning of charged ionic open bond structures for molecular covalent bonding during process synthesis.

It is another object of the invention to use the most penetrating frequencies of the said actinic field to stimulate photo-multiplication of secondary emissions within a positively charged ionic stream such that they can be used as a stereo-chemical facility for directing the linear alignment of the reaction required to synthesize a given chemical product.

It is yet another object of the invention to produce asymmetrical area strong chemical reactions within a rapid flowing stream to promote singular local kinetic wall force greater than the perpendicular equal pressure forces on both sides of a flowing axis within a reaction chamber.

### BRIEF DESCRIPTION OF THE DRAWINGS

Nine drawings are presented showing the individual elements of the invention and their assembly and how the assembly interfaces with the systems listed in the cross-references.

FIG. 1 is a side view of a cylinder having flanges at each end with portions cutaway to show cross-sectional structure.

FIG. 2a is a ceramic insulator plate.

FIG. 3 is the inlet electrical bus-bar.

FIG. 4 is a the electrical outlet-bus-bar of the return circuit.

FIG. 5 is the electrical collecting ring manifold of the return circuit.

FIG. 6 is the electrical distributing manifold of the inlet circuit bus-bars.

FIG. 7 is an electrical wire segment filament.

FIG. 8 is an assembly shown principally in cross-section.

FIG. 9 is a cross section of the invention.

### DETAILED DESCRIPTION OF THE INVENTION

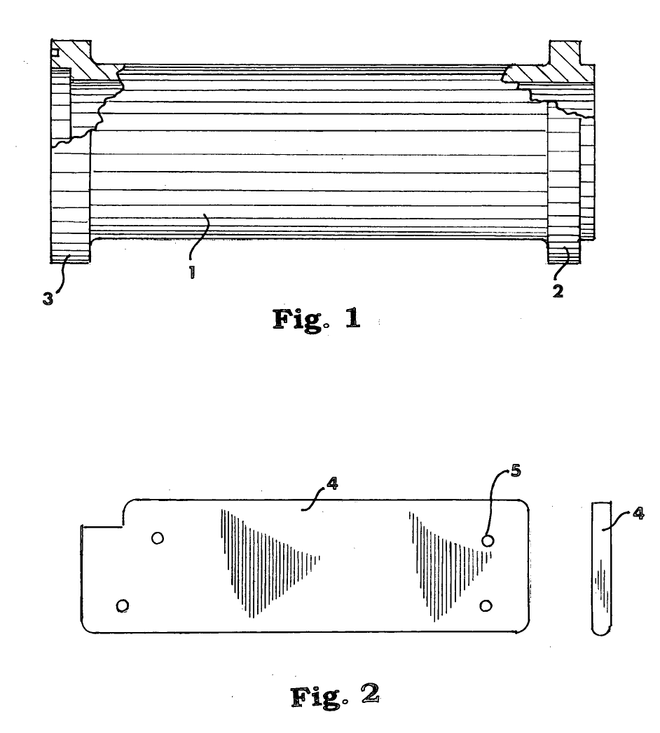

FIG. 1 is an alignment chamber fabricated as a ceramic cylinder 1 having an inlet flange 2 and a corresponding dimensional mating outlet flange 3 for assembly in the process flow of Ref. 3, or other charged streams. Cylinder 1 is constructed of any electrically low conducting material. The mating flanges permit easy assembly of a plurality of alignment chambers in series.

FIG. 2 is a ceramic insulator plate 4 having four assembly holes 5. Insulator plates are support structure for mounting an electrical bus-bar on each side.

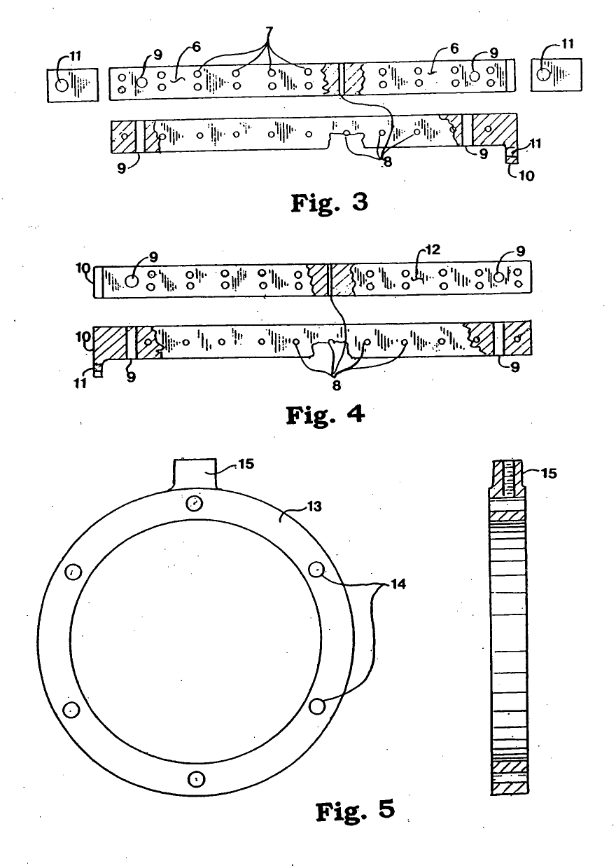

FIG. 3 is a side view of the electrical inlet bus-bar 6 having a plurality of drilled and tapped holes 7 for fixedly mounting a plurality of electrical filaments which pass upward from the plurality of filament holes 8 drilled through from the bottom surface of said inlet bus-bar 6. Also shown are two mounting holes 9 and mounting flange 10 with mounting hole 11.

FIG. 4 is the electrical outlet bus-bar 12 having the same drilled features of FIG. 3 inlet bus-bar duct is slightly longer in length.

FIG. 5 is an electrical collector ring outlet manifold 13 having a plurality of holes 14 for mounting bus-bar 12 flange 10 through hole 11. At the top of collector ring 13 is pole mounting boss 15 having a threaded mounting hole 16 for attachment to the return circuit cable.

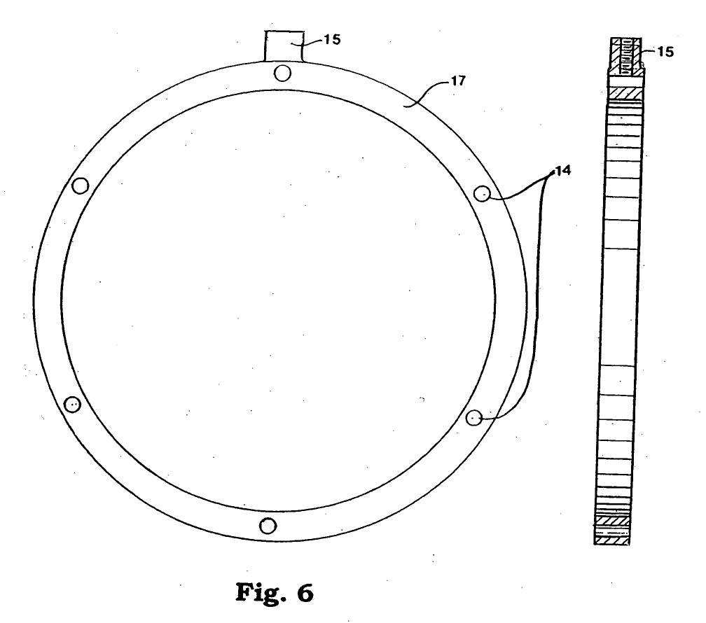

FIG. 6 is an electrical collector ring inlet manifold having the same features as FIG. 5 but is slightly larger in diameter.

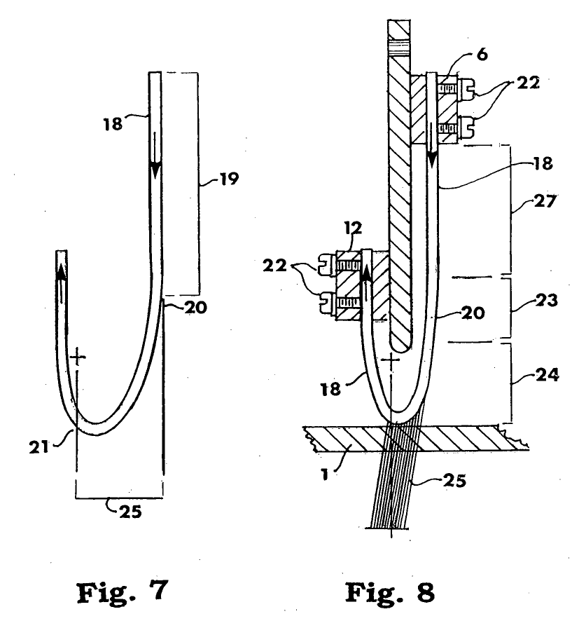

FIG. 7 is a frontal view of a wire segment filament 18. Filament wire 18 is formed as a hyperbolic spiral for best efficiency, however, any curve will produce an actinic radiation. Filament wire 18 could be formed as a continuous coil to form a plurality of actinic radiation points. This type of filament would radiate at a higher frequency than a single bend since radiation temperature is a function of the total filament electrical resistance a short segment bend is preferred since it can operate at high current surge without overheating and produce radiation in the terahertz frequency range. The straight inlet length 19 is an adjustable length. High current surge of the multiplex signal enters from inlet bus-bar 6 and encounters the higher resistance circuit 19 and begins to slow down and electron compaction begins in this area. As filament wire 18 begins its curve at inflection point 20 electron field distortion begins and actinic activity begins and continues to an increasing intensity to acceleration point 21. The total radiation field 22 is located between point 20 and point 21. Maximum field distortion and strongest radiation is at the bottom of the filament 18 curve.

FIG. 8 is a cross-section of a linear track showing filament 18 fixedly secured by set screws 22 to inlet bus-bar 6 mounted on plate 4. Said filament 18 curves under plate 4 and fixedly secured by set screws 22 to outlet bus-bar 12. The operating filament resistance range 23 is a calibration range. The initial inflection range 23 is not an effective radiation parameter. The steeper hyperbolic curvature 24 is the primary source of terahertz radiation field 25. The terahertz radiation penetrates the wall of cylinder 1.

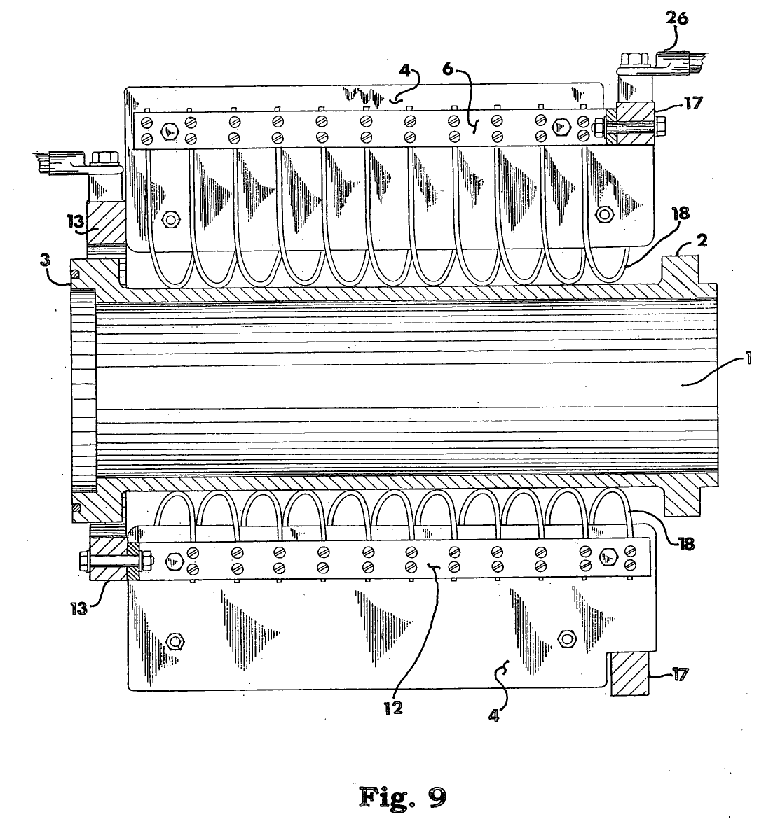

FIG. 9 is a cross-section of the assembled linear alignment chamber 1. A plurality of assembled linear tracks comprised of elements of FIG. 2, FIG. 3, FIG. 4 and FIG. 7 are radially mounted on alignment chamber 1 of FIG. 1 and electrically connected in parallel circuits by collector ring manifolds described in FIGS. 5 and 6. The multiplex high current signal enters the linear alignment chamber through inlet cable 26.

### NUMBERED ELEMENTS OF THE INVENTION

### Element

1. Cylinder
2. inlet flange
3. outlet flange
4. plate 4
5. Holes
6. inlet bus-bar
7. tapped holes
8. filament holes
9. hole
10. flange
11. hole
12. outlet bus-bar
13. outlet collector ring
14. holes
15. boss
16. cable mounting hole
17. inlet manifold ring
18. filament
19. resistance adjustment length
20. inflection point
21. acceleration point
22. set screws
23. inflection range
24. terahertz radiation field
25. terahertz radiation field
26. multiplex inlet cable

What is claimed is:

1. A plurality of short wire segments having a single bend forming a “U” shape element hereinafter termed a filament, each end of the said filament being fixedly attached to electrical conducting bus-bars, a plurality of said filaments fixedly attached across said bus-bars, said filaments, said bus-bars, separated and mounted on opposite surfaces of a flat rectangular insulator plate, said filaments, said bus-bars, mounted on said insulator plate, forming an assembly hereinafter termed a linear track, a non metallic cylinder hereinafter termed an alignment chamber, a plurality of said linear tracks being radially mounted perpendicularly and parallel with the longitudinal exterior surface axis of said alignment chamber, said bus-bars of said linear tracks being electrically manifolded by electrical collector rings mounted at each end of said alignment chamber to receive and transmit an electrical pulse.
